(19) United States
(12) Patent Application Publication
(10) Pub. No.: US 2012/0068933 A1
(43) Pub. Date: Mar. 22, 2012

(54) INTERACTIVE KEYBOARD WITH MULTIPLE DIFFERENT KEY ARRANGEMENTS

(75) Inventor: Glen C. Larsen, Issaquah, WA (US)

(73) Assignee: MICROSOFT CORPORATION, Redmond, WA (US)

(21) Appl. No.: 12/885,113

(22) Filed: Sep. 17, 2010

(51) Int. Cl. G06F 3/02

(52) U.S. Cl. 345/168

(57) ABSTRACT

A keyboard kit that is selectively configurable by an end user to provide differing key arrangements is provided. The keyboard kit includes a plurality of differently-configured keyboard modules and an underlying display device. Each of the plurality of differently-configured keyboard modules may be at least partially see-through and include mechanically-depressible keys, the underlying display device and plurality of differently-configured keyboard modules being configured such that, upon securing of a selected one of the plurality of differently-configured keyboard modules to the underlying display device, the selected one of the plurality of differently-configured keyboard modules covers at least a portion of an operative surface of the underlying display device and enables through-key user viewing of dynamic keyboard imagery from the underlying display device.

### BACKGROUND

Keyboards and other peripheral input devices are continually being refined to expand functionality and provide quality user experiences. One area of improvement has been to combine input and output capability in a peripheral device. For example, virtual keyboards have been incorporated into touch interactive displays to provide a more adaptive input experience. In this case, the display capability is provided directly on the keys: each key typically is displayed by the touch interactive display with a legend or symbol that indicates its function. The virtual keyboard approach has many benefits, including the ability to dynamically change the display and function for each key. However, interactive touch displays are often less desirable from a pure input standpoint. Specifically, touch displays do not provide tactile feedback, which can provide a more responsive and agreeable typing experience. Therefore, in many peripheral devices, tradeoffs are made between tactile response and dynamic functionality. Typically, when touch interactivity is provided in connection with a tactile keyboard, the touch interactivity is provided on a different portion of the device and is used for functionality other than keyboard-type inputs. The key layouts on these devices are fixed, and the dynamic benefits are achieved through a supplemental touch region.

### SUMMARY

Accordingly, the description is directed to a keyboard kit that is selectively configurable by an end user to provide differing key arrangements. In addition to providing differing key arrangements, many of the described embodiments employ a dynamic display output capability in connection with tactile keyboard keys. The keyboard kit includes a plurality of differently-configured keyboard modules and an underlying display device. Each of the plurality of differently-configured keyboard modules may be at least partially see-through and include mechanically-depressible keys. The underlying display device and keyboard modules are configured such that, upon securing a selected keyboard module to the underlying display device, the keyboard module covers at least a portion of an operative surface of the underlying display device and enables through-key user viewing of dynamic keyboard imagery from the underlying display device.

In this way, a user may select a desired keyboard layout for a keyboard, thereby increasing adaptability while retaining the tactile responsiveness provided by mechanically-depressible keys. Moreover, the imagery provided through the keys of the keyboard may be dynamically adjusted, further increasing the functionality of the keyboard.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 depicts a computing system including a keyboard kit with a plurality of differently-configured keyboard modules that can be selectively coupled to and positioned over an underlying display device that provides dynamic keyboard imagery which is viewable through the keyboard modules.

FIG. 2 depicts a portion of the keyboard kit shown in FIG. 1, and in particular shows a side view of a key that may be included in the differently-configured keyboard modules.

FIG. 3 depicts the computing system shown in FIG. 1 having a keyboard module secured to the underlying display device.

FIG. 4 illustrates an example of the output display capability that may be employed in connection with the keyboard kit of FIGS. 1 and 2.

FIG. 5 illustrates various exemplary keyboard modules that may be included in the keyboard kit shown in FIG. 1.

FIGS. 6-9 show various examples of how keyboard modules, such as those depicted in FIGS. 1 and 2, may be coupled with and secured to an underlying display device.

FIG. 10 shows a schematic depiction of the computing system shown in FIG. 1.

FIG. 11 depicts an exemplary method of enabling user selection of different key arrangements in connection with a keyboard.

### DETAILED DESCRIPTION

The present application is directed to a keyboard kit that is selectively configurable by an end user to provide differing key arrangements. The keyboard kit may include a plurality of differently-configured keyboard modules and an underlying display device. Each of the plurality of differently-configured keyboard modules may be at least partially see-through and include mechanically-depressible keys. The underlying display device may be configured to attach to the keyboard modules. When one of the differently-configured keyboard modules is attached to the underlying display device, a user may view dynamic imagery through a viewable portion of the keyboard module. In this way, a user may select different key layouts suited to their input needs for a keyboard that provides dynamically adjustable displayed output viewable through the keys as well as tactile responsiveness.

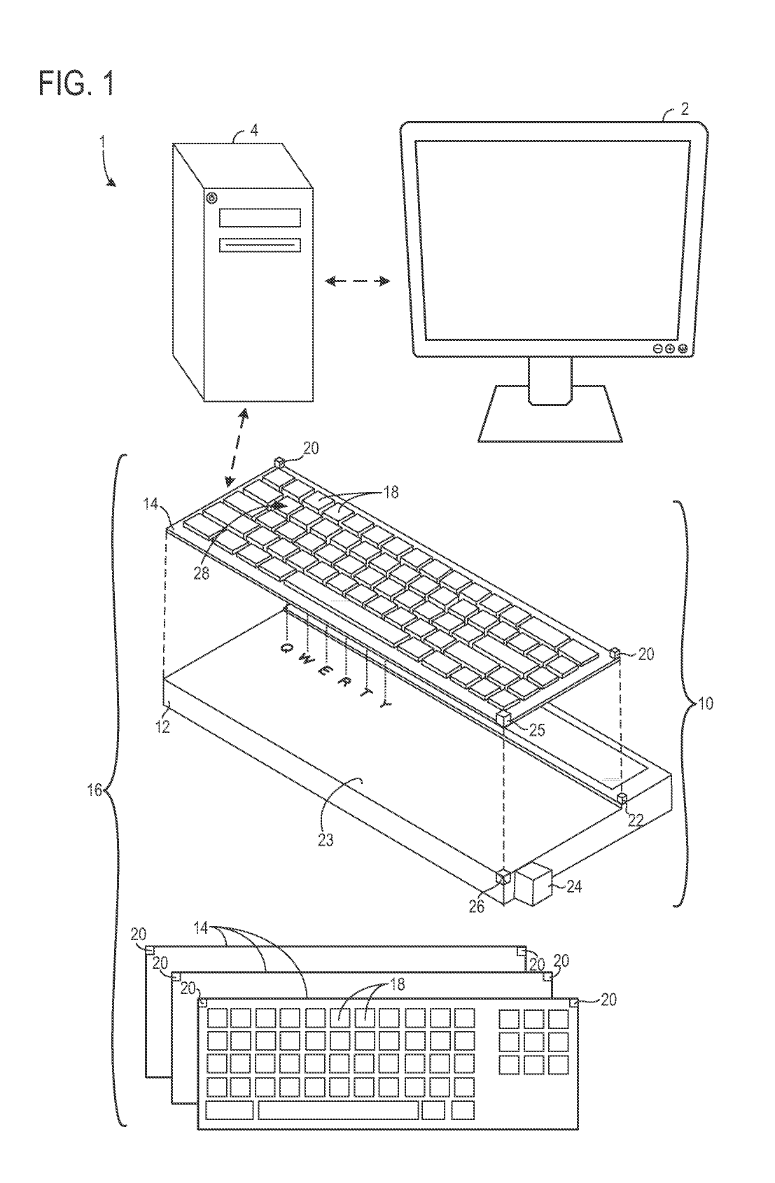

FIG. 1 depicts a computing system 1 including a display monitor 2, a computing device or component enclosure 4 (e.g., containing a processor, memory, hard drive, etc.), and a computer peripheral in the form of keyboard 10. The display monitor, computing device/enclosure, and keyboard may be in wired and/or wireless communication. The keyboard 10 may be provided, via user selection, with various different key arrangements. The keyboard 10 includes an underlying display device 12, over which various keyboard modules 14 may be situated. Specifically, different key arrangements may be achieved through multiple differently-configured keyboard modules 14 that may be provided as part of a keyboard kit 16. In this way the physical key layout of the differently-configured keyboard modules may differ from one another. It will be appreciated that the underlying display device may also be included as part of keyboard kit 16, though it is contemplated that the keyboard modules may be provided separately from the underlying display device. Each of the keyboard modules 14 may include a plurality of physically depressible keys 18. In other words, the individual keys are movable inward and outward as a result of a user pressing and releasing the keys. In this way, tactile response is provided to the end user during operation of the keyboard, enhancing keyboard operation. In some cases, the mechanical movement of the keys may be preferred by a user over other non-responsive keyboards; such as a keyboard presented on a touch sensitive display that does not provide tactile feedback.

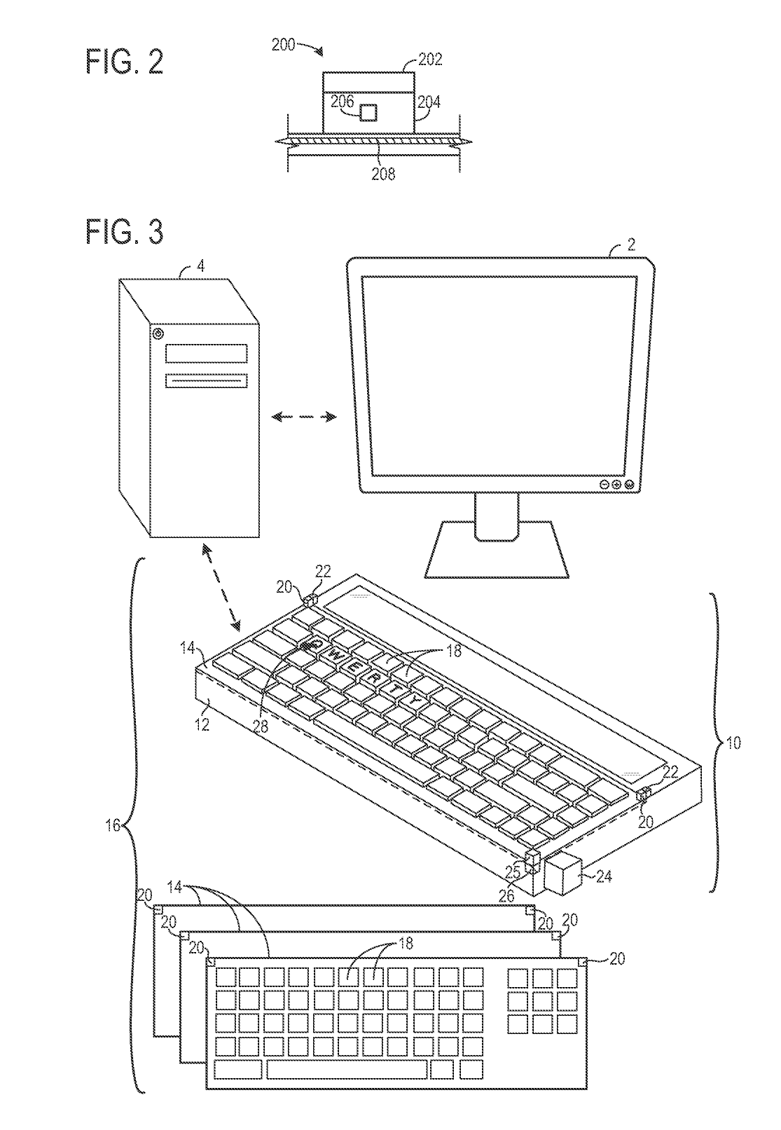

FIG. 2 shows a schematic representation of a physically depressible key 200 that may be included in the plurality of physically depressible keys 18, shown in FIG. 1. In connection with key movement, physically depressible key 200 may be provided with a key cap 202 coupled to a mechanical understructure 204 or other structure to guide and/or stabilize the in-and-out reciprocating movement of the key. In one particular example, the mechanical understructure 204 may be configured to maintain the physically depressible key 200 in alignment during movement and ensure that the movement is constrained to perpendicular linear movement toward and away from the underlying display device, without twisting, tilting, and the like. For example, it will generally be preferable that the top of the physically depressible key remains parallel with the underlying display device when the key is depressed. However, the mechanical understructure 204 may guide the key in another path during key actuation, in other examples.

In addition, a return force may be employed to urge the key back to a non-depressed position. A tactile feedback structure 206 may be configured to provide the return force when physically depressible key 200 is depressed. In this way, tactile feedback may be provided to the end user, thereby enhancing the user's typing experience. In some embodiments, tactile feedback is achieved by configuring the tactile feedback structure to provide a non-linear return force as a function of key displacement. Further in some embodiments, this non-linear characteristic may provide a “snapping” or “clicking” sensation that is palpably felt by the user during operation of the key, providing the user with haptic cues.

Various mechanical understructures and tactile feedback structures may be used to provide such tactile feedback and key movement. Suitable mechanical understructures may include but are not limited to a scissor understructure that may include two portions pivotably coupled via a pivot point. Each portion may include a pair of opposed webs with a pair of rods extending between the webs. Other mechanical understructures may include a stem and silo type understructure including a key cap having a stem configured to depressibly engage a silo during key depression. Suitable tactile feedback structures may include an elastomeric dome, a spring, resiliently deformable wires, etc.

Detection of key operation may be implemented through use of selectively enabled electrical connections that are switched on as a result of key operation. In some examples, physically depressible key 200 may be coupled to an electrical trace network 208 included in the keyboard module. Upon depression of the physically depressible key, an input signal associated with the key for controlling an operatively connected computing device may be generated by the electrical trace network. It will be appreciated that each key included in the keyboard module may be coupled to electrical trace network 208. In this way, operation of each key may be detected. However, in other examples, key operation may be optically detected by an optical subsystem, discussed in greater detail herein. Still further, key presses may be detected via touch interaction between key structures and the surface of the underlying display device.

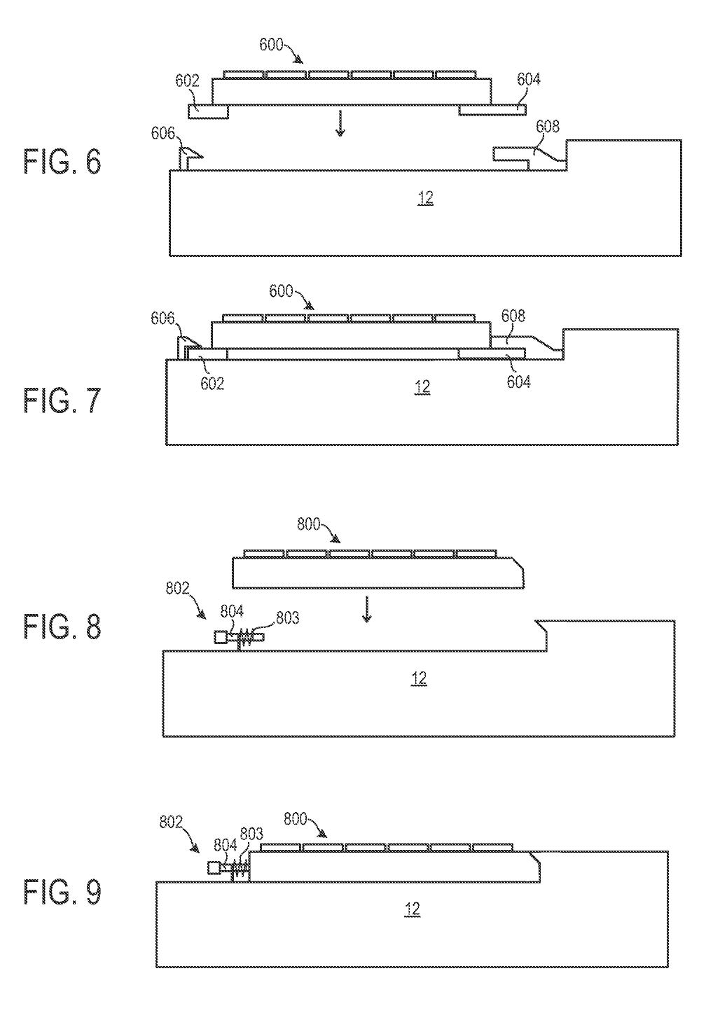

Returning to FIG. 1, each keyboard module may further include a plurality of module attachment structures 20. Likewise, the underlying display device may include a plurality of display attachment structures 22. The module attachment structures and display attachment structures may be configured to attach to one another, securing the keyboard module to the underlying display device. Therefore, a user may select a desired one of keyboard modules 14 and then secure it to an operative surface 23 of underlying display device 12 via the display attachment structures and the module attachment structures, as shown in FIG. 3. In some examples, the module attachment structures and display attachment structures may be adapted to engage one another quickly and easily via tool-free or other simple manipulation by the end user, as explained in greater detail below with regard to FIGS. 6-9.

In many implementations, underlying display device 12 provides dynamic keyboard imagery that is viewable through the mounted keyboard module. Underlying display device 12 may be implemented with a variety of technologies to provide dynamic keyboard imagery and other viewable display output. In some embodiments, a liquid crystal display may be employed, with optional touch screen capability provided via capacitive-based, resistive-based, or other suitable touch technology. In other examples, interactivity may be provided via optical detection, using machine vision or other appropriate techniques. Therefore in some examples, underlying display device 12 may include an optical subsystem 24. Although optical subsystem 24 is generically represented as a box it will be appreciated that the optical subsystem may include various optical components for optical detection. The optical subsystem may be configured to optically identify the keyboard module. However, in other examples, the keyboard module may be identified by the underlying display device via an electrical coupling 25 that is engaged with a corresponding display electrical coupling 26 upon securing of the keyboard module to the underlying display device, and where identification of the keyboard module occurs in response to transmissions through the electrical coupling. Input commands resulting from key depression may also be provided via the electrical coupling to control operatively connected computing device 4. However, in other embodiments, electrical coupling 25 and display electrical coupling 26 may not be included in the keyboard module. Additionally, the keyboard module may be identified by the underlying display device through touch sensing functionality at the operative surface of the underlying display device. In this way, the underlying display device or computing device may include executable instructions operative to identify which of the plurality of differently-configured keyboard modules is secured to the underlying display device.

As briefly mentioned above, underlying display device 12 may provide dynamic keyboard imagery that is viewable through a mounted keyboard module. Viewing is facilitated by configuring the keyboard modules so that they are at least partially transparent. This is achieved in some examples via a central viewing window provided in each key of the module (e.g., through use of a transparent polycarbonate or other appropriate see-through material). In this way, through-key viewing of dynamic imagery may be provided to the user. In addition, other structures may be made transparent, including the mechanical key understructure and electrical trace networks that provide output signals associated with operation of the various keys.

In many cases, the dynamic keyboard imagery may include viewable output specifically associated with individual keys, such as alphanumeric characters (e.g., key-associated displays “Q” “W” “E” “R” “T” “Y”). It will be appreciated that the displayed output may vary dynamically; for example, different display outputs may be produced for different software applications running on computing device 4.

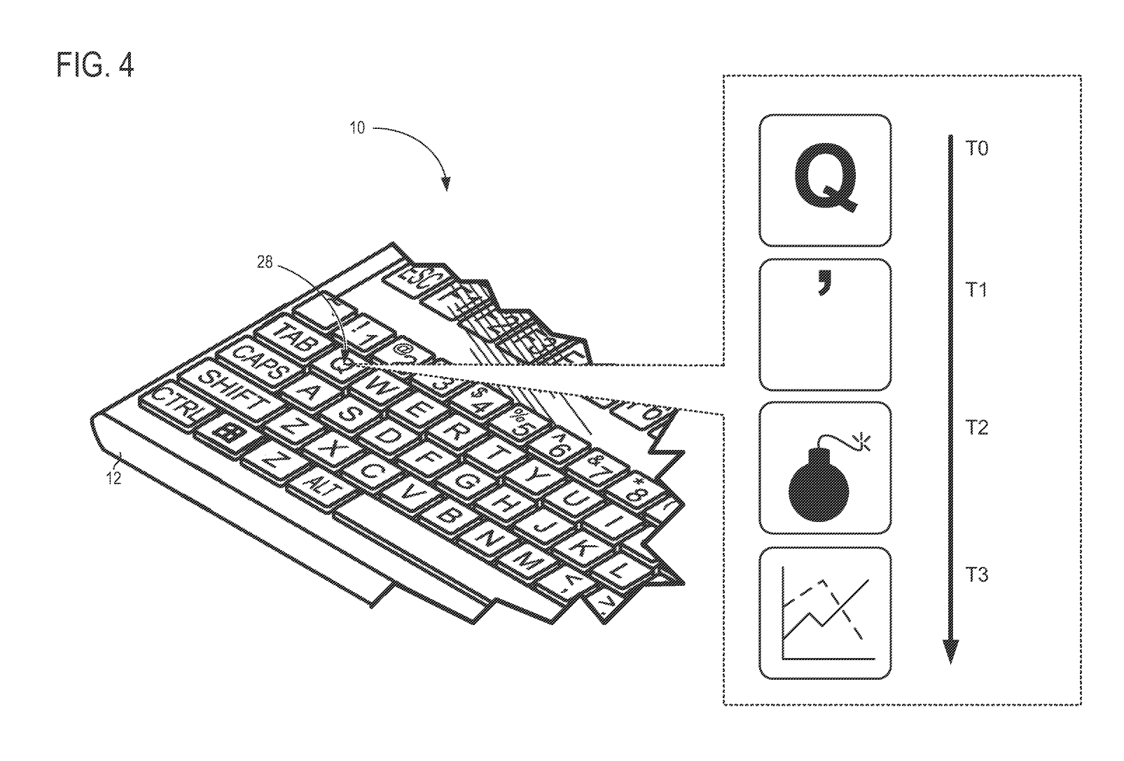

Now referring to FIG. 4, as shown respectively at times T₀, T₁, T₂, etc., the display output associated with a key 28 may be changed, for example to reflect the input command produced by depressing the key. However, the viewable output provided by the underlying display device may take forms other than displays associated with individual keys and their input functionality.

Returning to FIG. 3, in addition, the operational context of computing device 4 at any given point in time may dynamically produce a change in the displayed output of the underlying display device 12. For example, applications executed on computing device 4 may trigger adjustment of the displayed output. Further, it will be appreciated that the dynamic keyboard imagery may change dynamically in response to operation of individual keys on one of the keyboard modules 14. For example, depression of a key may cause one or more of the keys on the keyboard to indicate, via an altered display output, a secondary function of the depressed key.

It will be further appreciated that underlying display device 12 may function as a secondary, or auxiliary display, to provide viewable output in addition to that provided by display monitor 2 of computing device 4. As such, underlying display device 12 can provide output other than imagery associated with keyboard keys, and such viewable output may be provided underneath a keyboard module or on portions of the display device that are not covered by the keyboard module. Indeed, in some examples, keyboard kit 16 may include keyboard modules of varying footprints. For example, a smaller keyboard module may allow a greater portion of the underlying display device to be used for non-keyboard viewable output, touch interaction or otherwise.

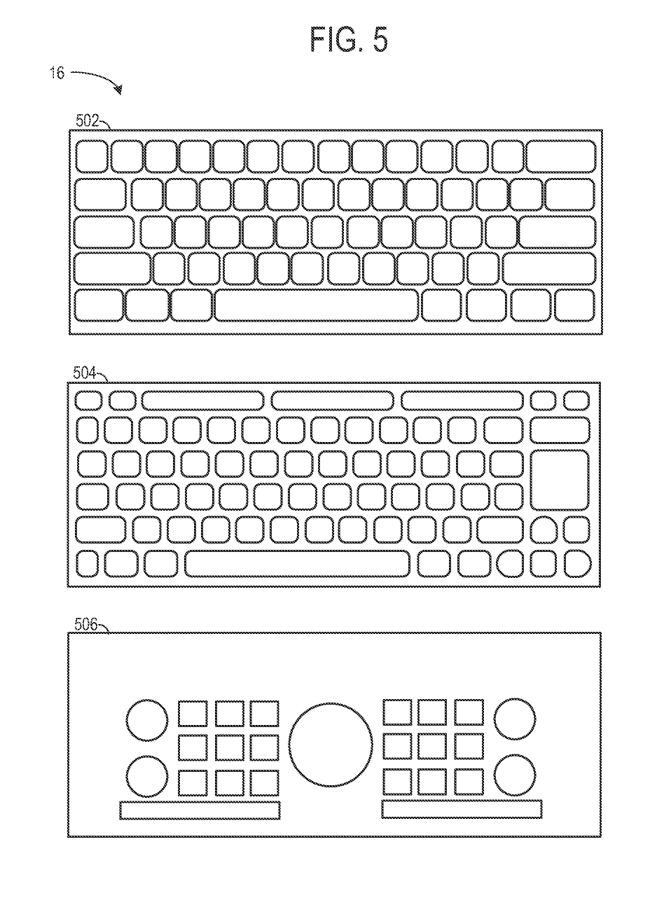

Referring now to FIG. 5, the figure shows an exemplary keyboard kit 16 of differently-configured keyboard modules (502, 504, and 506). As discussed above, each keyboard module may be secured to underlying display device 12 as shown in FIGS. 1, 3 and 4. Moreover, the underlying display device 12 may also be included in the keyboard kit. As indicated, the keyboard modules may differ with respect to a physical layout of keys. Physical layouts may differ in the number and placement of keys, in sizes and shapes of keys, in the overall footprint of the keyboard module, etc.

In some cases, a given physical layout may be in accordance with different geographically-associated standards or localizations. For example, the layout of the keys included in the keyboard module 502 may be in accordance with a generally accepted keyboard layout in the United States. Additionally, the layout of the keys included in the exemplary keyboard module 504 may be in accordance with a generally-accepted keyboard layout in Brazil. In this way, a first keyboard module, included in keyboard kit 16, has a key layout in accordance with a first geographic standard and a second keyboard module, included in keyboard kit 16, has a key layout in accordance with a second geographic standard. It will be appreciated that numerous other keyboard layouts in accordance with other geographic standards may be provided in keyboard kit 16. In this way, the keyboard kit can be marketed in a multitude of regions around the world, while utilizing a common display device 12. Furthermore, keyboard modules 502 and 504 may have a key layout for conventional typing operations and alphanumeric character entry.

Other keyboard modules may be designed for other purposes, such as specific software applications. For example, keyboard module 506 is designed for use with a gaming application. As shown, the physical layout of the keys is designed to enhance game play of a gaming application. For example, the layout of the keys may enable rapid execution of commands frequently used during game play.

Other types of keyboard modules that may be in keyboard kit 16 include a computer-aided design (CAD) keyboard module designed for use with computer-aided design applications and/or a numerical entry keyboard module designed for use with accounting or other types of bookkeeping applications. Other keyboard modules may be designed with particular attention to ergonomic considerations; for example, keyboard kit 16 may include a keyboard module having a split configuration, in which one half of the keys are provided in a left-hand group that is situated at a different angle than a right-hand group of keys, thereby providing a biomechanically-enhanced design, decreasing the likelihood of an end user developing repetitive strain injuries (RSI). The keyboard kit enables a user to quickly and easily swap out keyboard layouts designed for specific software programs (e.g., software applications) in use on computing device 4. In other words, a user can select keyboard modules with different layouts based on the software application in use on the computing device, enhancing the user's input experience.

In some examples, a default display setting may be provided for each keyboard module. For instance, the underlying display device may detect attachment of a specific type of keyboard module. In response to the detection, the underlying display device may provide a default display output associated with the type of keyboard module that was detected. The default display output may include predetermined imagery (e.g., alphanumeric symbols, graphics, etc.) corresponding to the keys on the keyboard module.

As indicated above, underlying display device 12 and keyboard modules 14 may be configured to enable easy tool-free attachment of a given keyboard module to the underlying display device. In other words, the end user may be able to attach a keyboard module to underlying display device 12 with just the use of their hands. FIGS. 6-9 show various structures for attaching the keyboard modules to the underlying display device.

FIG. 6 illustrates exemplary keyboard module 600 detached from underlying display device 12. It will be appreciated that keyboard module 600 may be included in keyboard kit 16. The keyboard module includes at least a first and a second module attachment apparatus, 602 and 604 respectively. Correspondingly, the underlying display device includes at least a first display attachment apparatus 606 being resiliently deformable and a second display attachment apparatus 608. The first module attachment apparatus 602 is configured to engage to the first display attachment apparatus 606. Likewise, the second module attachment apparatus 604 is configured to engage the second display attachment apparatus 608.

To secure the keyboard module to the underlying display apparatus a user may mate the second module attachment apparatus with the second display attachment apparatus. Subsequently, a force may be applied by the user's hand to bend the first display attachment apparatus 606. The entire keyboard module may then be positioned on a display surface of the underlying display device. The user may then discontinue manipulation of the keyboard, leaving the first display attachment apparatus 606 engaged with the first module attachment apparatus 602 and the second display attachment apparatus 608 engaged with the second module attachment apparatus 604, as shown in FIG. 7.

FIGS. 8 and 9 show an alternate structure that may be used to secure a keyboard module 800 to the underlying display device 12. It will be appreciated that keyboard module 800 may be included in the keyboard kit 16.

FIG. 8 illustrates keyboard module 800 detached from the underlying display device 12. As shown, the underlying display device includes a display attachment apparatus 802 having a spring 803 or other resiliently deformable structure, material, etc., coupled to a feature 804. The spring may be configured to provide a resistive force to lateral movement of the feature. The keyboard module may include a module attachment apparatus (not shown) having an opening sized to accept feature 804. To attach the keyboard module to the underlying display device a user may pull the feature laterally outward with their hand, place the keyboard module on a display surface of the underlying display device, and subsequently release the feature. After the feature is released, it will return to its original position and mate with the opening in the keyboard module. In this way, the keyboard module may be secured to the underlying display device. Additionally or alternatively, screws or other joining method may be used to attach the keyboard module to the underlying display device. It will be appreciated that the attachment apparatuses shown in FIGS. 6-9 are exemplary in nature and other suitable attachment apparatuses may be used to secure the keyboard module to the underlying display device in other embodiments.

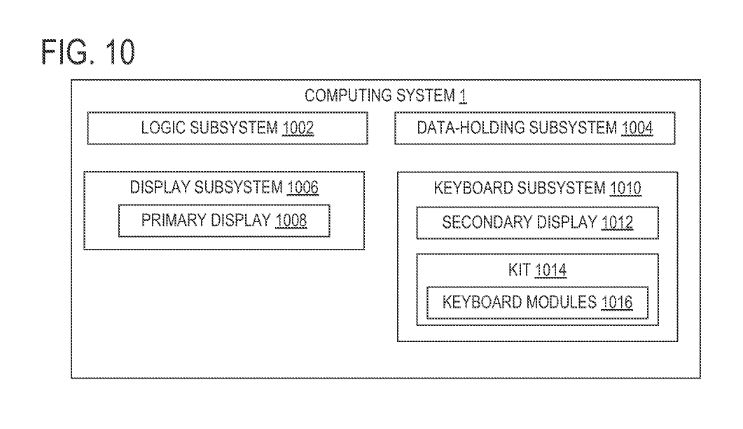

FIG. 10 schematically shows a nonlimiting computing system 1 having swappable and varied keyboard configurations. Computing system 1 is shown in simplified form. It is to be understood that virtually any computer architecture may be used without departing from the scope of this disclosure. In different embodiments, computing system 1 may take the form of a mainframe computer, server computer, desktop computer, laptop computer, tablet computer, home entertainment computer, network computing device, mobile computing device, mobile communication device, gaming device, etc. Computing system 1 may also include user input devices such as keyboards, mice, game controllers, cameras, microphones, and/or touch screens, for example.

Computing system 1 includes a logic subsystem 1002 and a data-holding subsystem 1004. Computing system 1 may optionally include a display subsystem 1006. Computing system 1 may also include a communication subsystem and/or other components not shown in FIG. 10.

Logic subsystem 1002 may include one or more physical devices configured to execute one or more instructions. For example, the logic subsystem may be configured to execute one or more instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

The logic subsystem may include one or more processors that are configured to execute software instructions. Additionally or alternatively, the logic subsystem may include one or more hardware or firmware logic machines configured to execute hardware or firmware instructions. Processors of the logic subsystem may be single core or multicore, and the programs executed thereon may be configured for parallel or distributed processing. The logic subsystem may optionally include individual components that are distributed throughout two or more devices, which may be remotely located and/or configured for coordinated processing. One or more aspects of the logic subsystem may be virtualized and executed by remotely accessible networked computing devices configured in a cloud computing configuration.

Data-holding subsystem 1004 may include one or more physical, non-transitory devices configured to hold data and/or instructions executable by the logic subsystem to implement the methods and processes described herein. When such methods and processes are implemented, the state of data-holding subsystem 1004 may be transformed (e.g., to hold different data).

Data-holding subsystem 1004 may include removable media and/or built-in devices. Data-holding subsystem 1004 may include optical memory devices (e.g., CD, DVD, HD-DVD, Blu-Ray Disc, etc.), semiconductor memory devices (e.g., RAM, EPROM, EEPROM, etc.) and/or magnetic memory devices (e.g., hard disk drive, floppy disk drive, tape drive, MRAM, etc.), among others. Data-holding subsystem 1004 may include devices with one or more of the following characteristics: volatile, nonvolatile, dynamic, static, read/write, read-only, random access, sequential access, location addressable, file addressable, and content addressable. In some embodiments, logic subsystem 1002 and data-holding subsystem 1004 may be integrated into one or more common devices, such as an application-specific integrated circuit or a system on a chip. As discussed above, the data-holding subsystem may be in the form of removable computer-readable storage media, which may be used to store and/or transfer data and/or instructions executable to implement the methods and processes described herein. Removable computer-readable storage media may take the form of CDs, DVDs, HD-DVDs, Blu-Ray Discs, EEPROMs, and/or floppy disks, among others.

A display subsystem 1006 may be used to present a visual representation of data held by data-holding subsystem 1004. The display subsystem may include a primary display 1008 for providing visual output. It will be appreciated that primary display 1008 may be a display monitor, such as display monitor 2 shown in FIG. 1. As the methods and processes described herein change the data held by the data-holding subsystem, and thus transform the state of the data-holding subsystem, the state of display subsystem 1006 may likewise be transformed to visually represent changes in the underlying data. Display subsystem 1006 may include one or more display devices utilizing virtually any type of technology. Such display devices may be combined with logic subsystem 1002 and/or data-holding subsystem 1004 in a shared enclosure, or such display devices may be peripheral display devices.

Computing system 1 may further include a keyboard subsystem 1010. The keyboard subsystem may include a secondary display 1012, such as underlying display device 12 discussed above. The keyboard subsystem may also include a kit 1014, such as keyboard kit 16 discussed above, of differently-configured keyboard modules 1016, each of which includes mechanically-depressible keys and is configured to be secured to and positioned over an operative surface of the secondary display. Differently-configured keyboard modules 1016 may be similar to differently-configured keyboard modules 14 discussed above. A first one of the kit of differently-configured keyboard modules may be adapted for conventional alphanumeric character entry, with a second one of the kit of differently-configured keyboard modules being adapted to provide inputs for a particular software application or type of software application. It will be appreciated that the keyboard module adapted to provide input for a software application enhances the user's input experience during operation of the software application by providing a key layout which may facilitate quick data entry.

Whereupon a selected one of the kit of differently-configured keyboard modules 1016 is secured to secondary display 1012, said selected one of the kit of differently-configured keyboard modules permits through-key viewing of dynamic keyboard imagery produced by the secondary display device. The dynamic imagery allows the keyboard to be adapted for use for different input scenarios. Viewing is facilitated by configuring the keyboard modules so that they are at least partially transparent, as discussed above.

In one example, data-holding subsystem 1004 may contain instructions executable by logic subsystem 1002. Said instructions, when executed, may be operative to, upon securing of said selected one of the kit of differently-configured keyboard modules 1016 to the secondary display 1012, identify said selected one of the kit of differently-configured keyboard modules. The instructions when executed may further be operative to configure computing system 1 and secondary display 1012 to provide, for each mechanically-depressible key of said selected one of the kit of differently-configured keyboard modules, a visual output associated with the mechanically-depressible key and visually representative of an input command which will result from user operation of the mechanically-depressible key.

In some examples, the instructions executable by data-holding subsystem 1004 may cause identification of said selected one of the kit of differently-configured keyboard modules via data transmitted along an electrical connection that is established between secondary display 1012 and said selected one of kit 1014 upon securing of said selected one of the kit of differently-configured keyboard modules to the secondary display.

In additional examples, the instructions executable by data-holding subsystem 1004 may cause identification of said selected one of kit 1014 via sensing performed by an optical subsystem of the computing system.

It will be further understood that the disclosure encompasses a method of enabling user selection of different key arrangements for a keyboard, and more particularly in certain implementations, with respect to a keyboard having a display device that provides viewable display output. The different key arrangements may be achieved through use of a kit including a plurality of differently-configured keyboard modules, such as the keyboard modules described above in connection with various examples. In particular, the keyboard modules include mechanically-depressible keys and are at least partially see-through to enable viewing of dynamic keyboard imagery from an underlying display device.

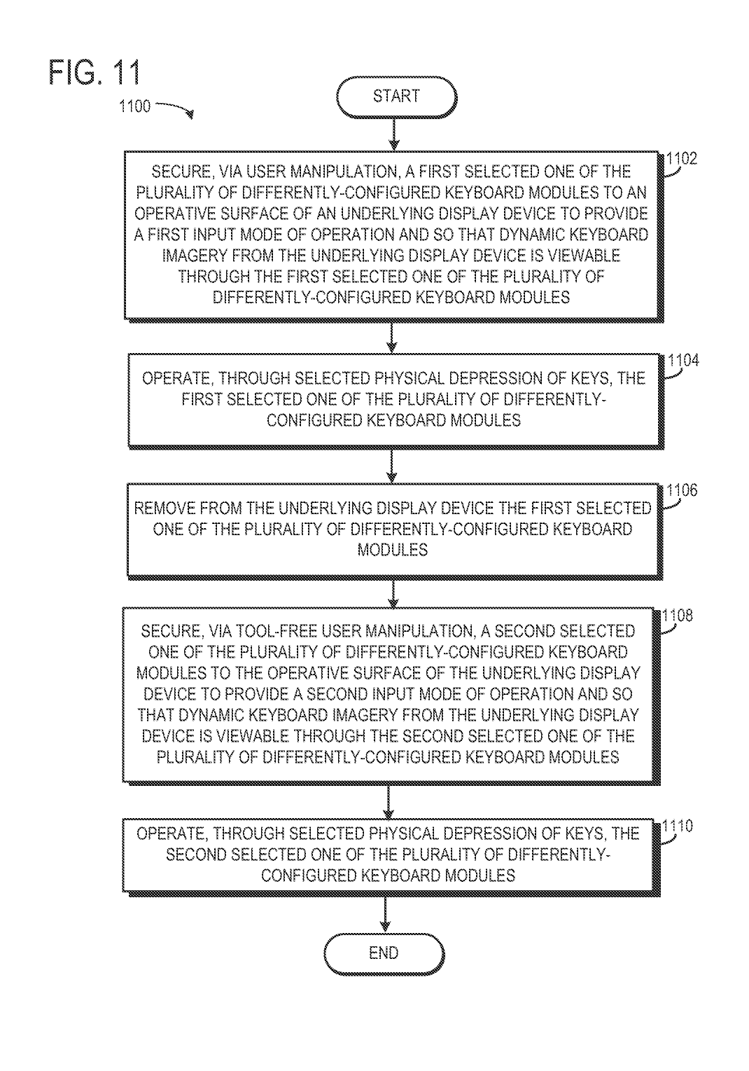

Now referring to FIG. 11, at 1102, exemplary method 1100 includes securing, via tool-free or other user manipulation, a first selected one of the plurality of differently-configured keyboard modules to an operative surface of an underlying display device to provide a first input mode of operation and so that dynamic keyboard imagery from the underlying display device is viewable through the first selected one of the plurality of differently-configured keyboard modules. In this way, a user may quickly and easily attach a keyboard module to an underlying display.

The method further includes, as shown at 1104, operating, through selected physical depression of keys, the first selected one of the plurality of differently-configured keyboard modules.

The method includes at 1106 removing from the underlying display device the first selected one of the plurality of differently-configured keyboard modules.

The method also includes at 1108 securing, via tool-free or other simple user manipulation, a second selected one of the plurality of differently-configured keyboard modules to the operative surface of the underlying display device to provide a second input mode of operation and so that dynamic keyboard imagery from the underlying display device is viewable through the second selected one of the plurality of differently-configured keyboard modules.

The method further includes at 1110 operating, through selected physical depression of keys via the end user, the second selected one of the plurality of differently-configured keyboard modules. In this way, a user may select various key layouts for different input scenarios, enhancing the keyboard's adaptability while retaining tactile responsiveness via the mechanically-depressible keys. Moreover, the dynamic imagery displayed through the keys further enhances adaptability.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A keyboard kit that is selectively configurable by an end user to provide differing key arrangements, comprising:
a plurality of differently-configured keyboard modules; and
an underlying display device,
where each of the plurality of differently-configured keyboard modules is at least partially see-through and includes mechanically-depressible keys, the underlying display device and plurality of differently-configured keyboard modules being configured such that, upon securing of a selected keyboard module of the plurality of differently-configured keyboard modules to the underlying display device, the selected keyboard module covers at least a portion of an operative surface of the underlying display device and enables through-key user viewing of dynamic keyboard imagery from the underlying display device.

2. The keyboard kit of claim 1, where at least one of the plurality of differently-configured keyboard modules differs in its physical key layout from another of the plurality of differently-configured keyboard modules.

3. The keyboard kit of claim 1, where at least one of the plurality of differently-configured keyboard modules includes a key layout for conventional typing operations and alphanumeric character entry, with another of the plurality of differently-configured keyboard modules having a key layout specifically adapted for a gaming application.

4. The keyboard kit of claim 1, where at least one of the plurality of differently-configured keyboard modules has a key layout in accordance with a first geographic standard, with another of the plurality of differently-configured keyboard modules having a key layout in accordance with a second geographic standard.

5. The keyboard kit of claim 1, where the underlying display device and each of the plurality of differently-configured keyboard modules include an electrical coupling that is engaged upon securing the selected keyboard module to the underlying display device, and where input commands resulting from key depression are provided via the electrical coupling to control an operatively connected computing device.

6. The keyboard kit of claim 1, further comprising executable instructions operative to identify the selected keyboard module which is secured to the underlying display device.

7. The keyboard kit of claim 6, where the underlying display device and each of the plurality of differently-configured keyboard modules include an electrical coupling that is engaged upon securing of the selected keyboard module to the underlying display device, and where identification of the selected keyboard module occurs in response to transmissions through the electrical coupling.

8. The keyboard kit of claim 6, where identification of the selected keyboard module occurs optically via an optical subsystem.

9. The keyboard kit of claim 6, where identification of the selected keyboard module occurs via one of: (i) touch sensing occurring at the operative surface of the underlying display device; (ii) magnetic detection during coupling of the selected keyboard module with the underlying display device; and (iii) mechanically-triggered sensing during coupling of the keyboard module with the underlying display device.

10. The keyboard kit of claim 1, where an electrical trace network of the selected keyboard module provides, upon depression of a key of the selected keyboard module, an input signal associated with the key for controlling an operatively connected computing device.

11. The keyboard kit of claim 1, where the underlying display device includes touch sensing functionality to detect depression of the mechanically-depressible keys of the plurality of differently-configured keyboard modules.

12. The keyboard kit of claim 1, further comprising an optical subsystem operative to detect depression of the mechanically-depressible keys of the plurality of differently-configured keyboard modules.

13. A computing system having swappable and varied keyboard configurations, comprising:
a display subsystem including a primary display for providing visual output;
a keyboard subsystem including a secondary display and a kit of differently-configured keyboard modules, each of which includes mechanically-depressible keys and is configured to be secured to and positioned over an operative surface of the secondary display, where upon securing a selected keyboard module of the kit of differently-configured keyboard modules to the secondary display, said selected keyboard module permits through-key viewing of dynamic keyboard imagery produced by the secondary display; and
a data-holding subsystem containing instructions executable by a logic subsystem, said instructions when executed being operative to, upon securing of said selected keyboard module to the secondary display, identify said selected keyboard module and then configure the computing system and secondary display to provide, for each mechanically-depressible key of said selected keyboard module, a visual output associated with the mechanically-depressible key and visually representative of an input command which will result from user operation of the mechanically-depressible key.

14. The computing system of claim 13, where at least one keyboard module of the kit of differently-configured keyboard modules differs from another keyboard module of the kit of differently-configured keyboard modules in physical layout of keys.

15. The computing system of claim 13, where the instructions cause identification of said selected keyboard module via data transmitted along an electrical connection that is established between the secondary display and said selected keyboard module upon securing of said selected keyboard module to the secondary display.

16. The computing system of claim 13, where the instructions cause identification of said selected keyboard module via sensing performed by an optical subsystem of the computing system.

17. The computing system of claim 13, where a first keyboard module of the kit of differently-configured keyboard modules is adapted for conventional alphanumeric character entry, with a second keyboard module of the kit of differently-configured keyboard modules being adapted to provide inputs for a particular software application or type of software application.

18. A method of enabling user selection of different key arrangements with respect to a keyboard, the different key arrangements being achieved through a kit including a plurality of differently-configured keyboard modules that are at least partially see-through and include mechanically-depressible keys, comprising:
securing, via tool-free user manipulation, a first selected keyboard module of the plurality of differently-configured keyboard modules to an operative surface of an underlying display device to provide a first input mode of operation and so that dynamic keyboard imagery from the underlying display device is viewable through the first selected keyboard module;
operating, through selected physical depression of keys, the first selected keyboard module;
removing from the underlying display device the first selected keyboard module;
securing, via tool-free user manipulation, a second selected keyboard module of the plurality of differently-configured keyboard modules to the operative surface of the underlying display device to provide a second input mode of operation and so that dynamic keyboard imagery from the underlying display device is viewable through the second selected keyboard module; and
operating, through selected physical depression of keys, the second selected keyboard module.

19. The method of claim 18, where the first selected keyboard module has a physical layout in accordance with a first geographic standard, and where the second selected keyboard module has a physical layout in accordance with a second geographic standard.

20. The method of claim 18, where the first selected keyboard module has a physical layout for a particular software application or type of software application.
